(19) United States
(12) Patent Application Publication
(10) Pub. No.: US 2016/0290616 A1
(43) Pub. Date: Oct. 6, 2016

(54) TREE ORNAMENT LIGHT SWITCH

(71) Applicant: Joe Pantaleo, Woodbridge (CA)

(72) Inventor: Joe Pantaleo, Woodbridge (CA)

(21) Appl. No.: 14/677,674

(22) Filed: Apr. 2, 2015

(51) Int. Cl. F21V 23/04; F21V 33/00

(52) U.S. Cl. CPC F21V 23/0435; F21V 33/0028; F21W 2121/04

(57) ABSTRACT

A tree ornament light switch includes a remote, an assembly and a tree ornament. The remote is wireless. The assembly includes an electrical receptacle, an electrical plug and a circuit. The circuit: has a first configuration wherein, in use, the plug and the receptacle are electrically coupled together and the receptacle is live; has a second configuration wherein the receptacle is dead; and is adapted for movement between the first and second configurations in response to the wireless remote. The tree ornament is adapted to releasably receive the remote.

### BACKGROUND OF THE INVENTION

1. Field of the Invention

The present invention relates to the field of seasonal lighting.

2. Prior Art

It is commonplace in many cultures for trees to be decorated with light strings in festive seasons. It is also commonplace for these trees to be decorated with ornaments, such as Christmas balls. Christmas balls are simply placed on the tree at the beginning of the season, enjoyed throughout the season, and removed at season's end. In contrast, light strings typically receive regular attention, as they are commonly turned on and off at least daily. This results in significant annoyance in the many households which lack suitably-located hard-wired switched receptacles. In these households, a not-uncommon twice-nightly duty is to crawl beneath the tree and switch the power bar to which the light strings are attached.

### SUMMARY OF THE INVENTION

Apparatus for use with an assembly forms one aspect of the invention. The assembly is of the type including an electrical receptacle, an electrical plug and a circuit. The circuit: has a first configuration wherein, in use, the plug and the receptacle are electrically coupled together and the receptacle is live; has a second configuration wherein the receptacle is dead; and is adapted for movement between the first and second configurations in response to a wireless signal. The apparatus comprises: a wireless remote having a user-manipulable switch and adapted to produce the signal responsive to manipulation of the switch; and a tree ornament adapted to releasably receive the remote.

According to another aspect of the invention: the switch can have an inactive position and an active position and be biased for movement towards the inactive position; and manipulation of the switch from the inactive position to the active position can cause the circuit to move between the first configuration and the second configuration.

According to another aspect of the invention, the tree ornament can be a Christmas ball.

According to another aspect of the invention, the Christmas ball can have a socket; and, in use: the socket can present downwardly; and the switch can present downwardly and be manipulable by the thumb of a hand grasping the Christmas ball.

According to another aspect of the invention: the tree ornament can be adapted to releasably receive the remote in one or more of frictional and mechanical engagement.

According to another aspect of the invention, the switch can be a button switch. Forming another aspect of the invention is a system comprising: wireless remotes; and tree ornaments, each ornament being adapted to releasably receive one of the remotes.

According to another aspect of the invention, the system can further comprise: assemblies, each assembly including an electrical receptacle, an electrical plug and a circuit, the circuit: having a first configuration wherein, in use, the plug and the receptacle are electrically coupled together and the receptacle is live; having a second configuration wherein the receptacle is dead; and being adapted for movement between the first and second configurations in response to one of the wireless remotes.

According to another aspect of the invention, each assembly can be adapted such that, when the plug is engaged in a wall receptacle, said each assembly is mounted to the wall.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 is a bottom perspective view of an apparatus according to an exemplary embodiment of the invention;

FIG. 2 is an exploded view of the apparatus of FIG. 1;

FIG. 3 is a top perspective view of the apparatus of FIG. 1;

FIG. 4 is a bottom view of the apparatus of FIG. 1;

FIG. 5 is a top view of the apparatus of FIG. 1;

FIG. 6 is a side view of the apparatus of FIG. 1;

FIG. 7 is a front view of the apparatus of FIG. 1;

FIG. 8 is a view of a system according to an exemplary embodiment of the invention and including the structure of FIG. 1;

FIG. 9 is a bottom view of the structure in encircled area 9 of FIG. 2; and

FIG. 10 is a view along section 10-10 of FIG. 9.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

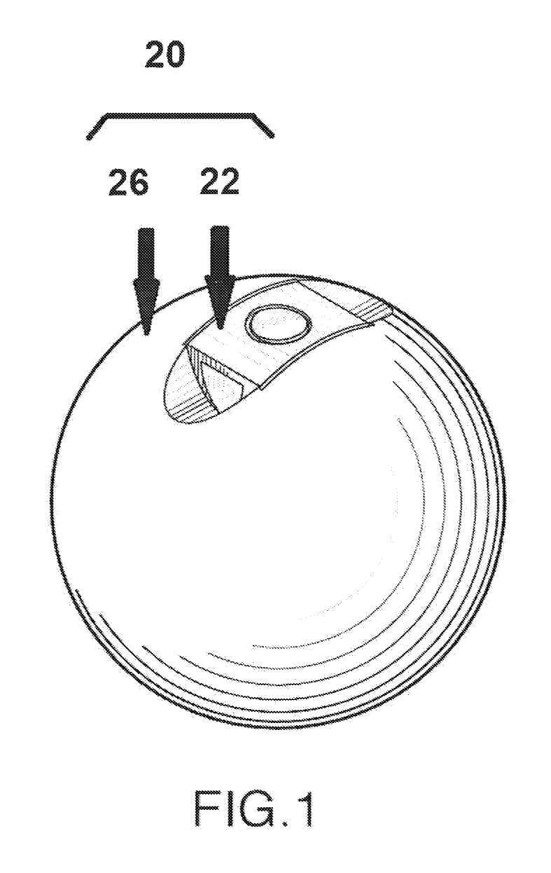

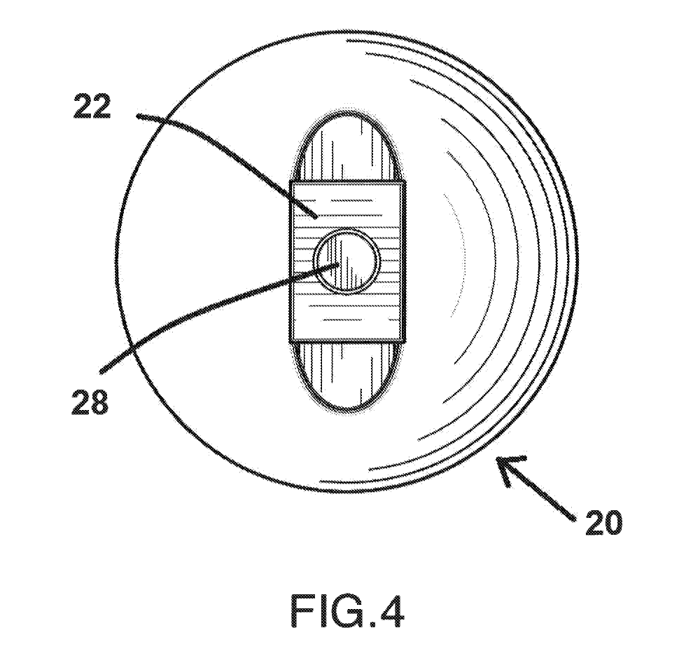

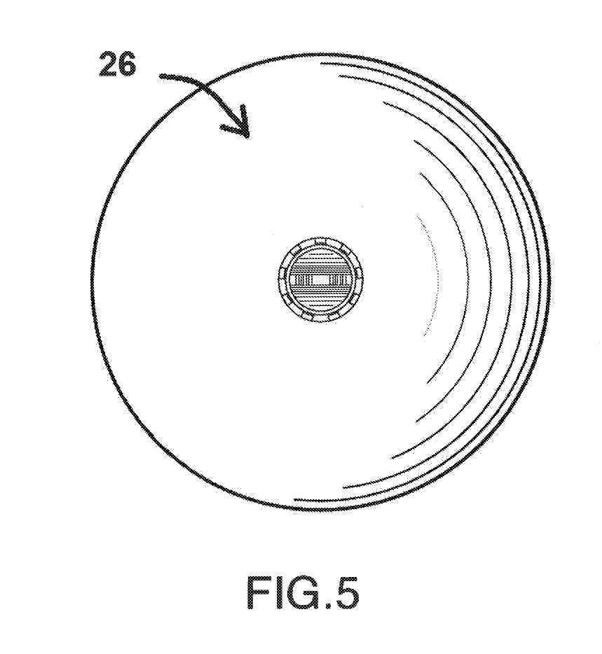

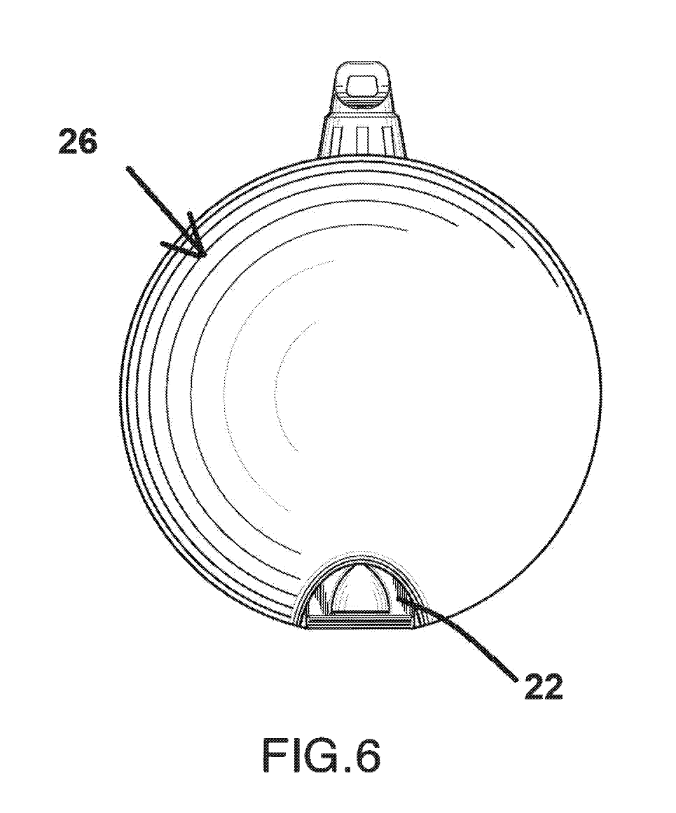

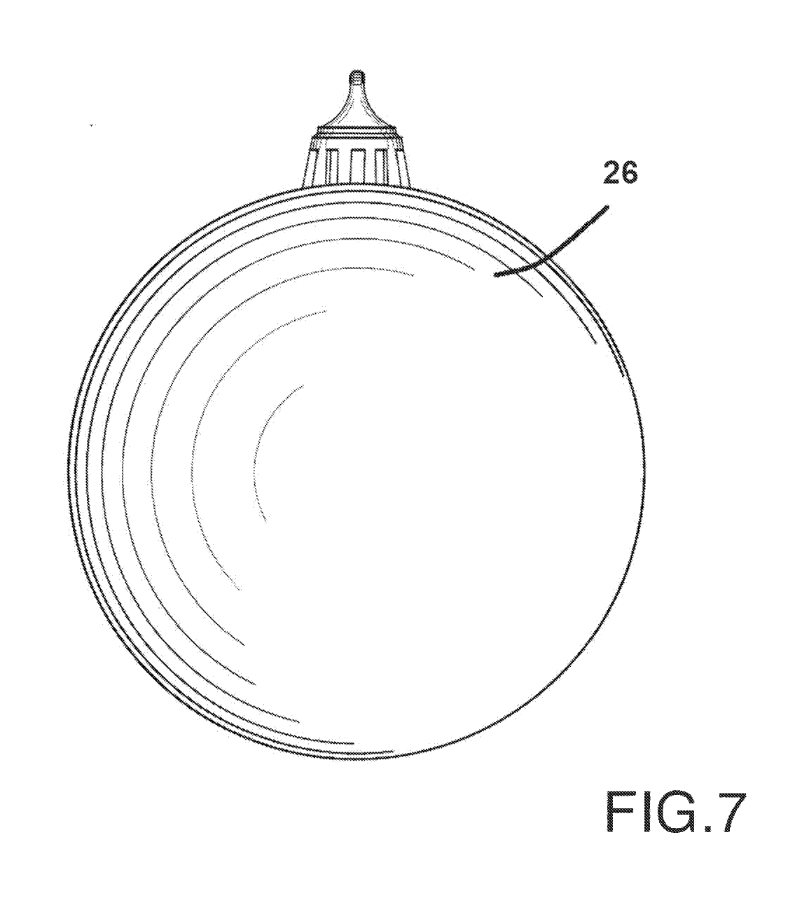

Apparatus 20 according to an exemplary embodiment of the invention is illustrated in FIGS. 1-7 and will be seen to comprise a remote 22 and a tree ornament 26.

The remote 22 is a wireless remote having a user-manipulable button switch 28. That is, the remote 22 will be understood to include interiorly a battery-powered transmitter capable of producing wireless signals, such as IR or RF signals, which signals are initiated, terminated or varied in response to manipulation of the switch. The remote 22 has opposed front and rear walls 40 and opposed side walls 42. In each side wall 42 there is defined a groove 44 and a recess 46. In this exemplary embodiment: the switch 28 has an inactive position and an active (depressed) position and is biased for movement towards the inactive position.

The tree ornament 26, which in this exemplary embodiment takes the form of a Christmas ball, is adapted to releasably receive the remote 22 by means of a socket 36 which receives the remote 22 in frictionally and mechanically-engaged relation. The socket 36 is shown in receipt of the remote 22 in FIG. 1 and it will be understood that the remote 22 can be withdrawn from the socket 36 by a user who grips the remote 22 between, for example, forefinger and thumb (not shown) using the recesses 46 to improve grip.

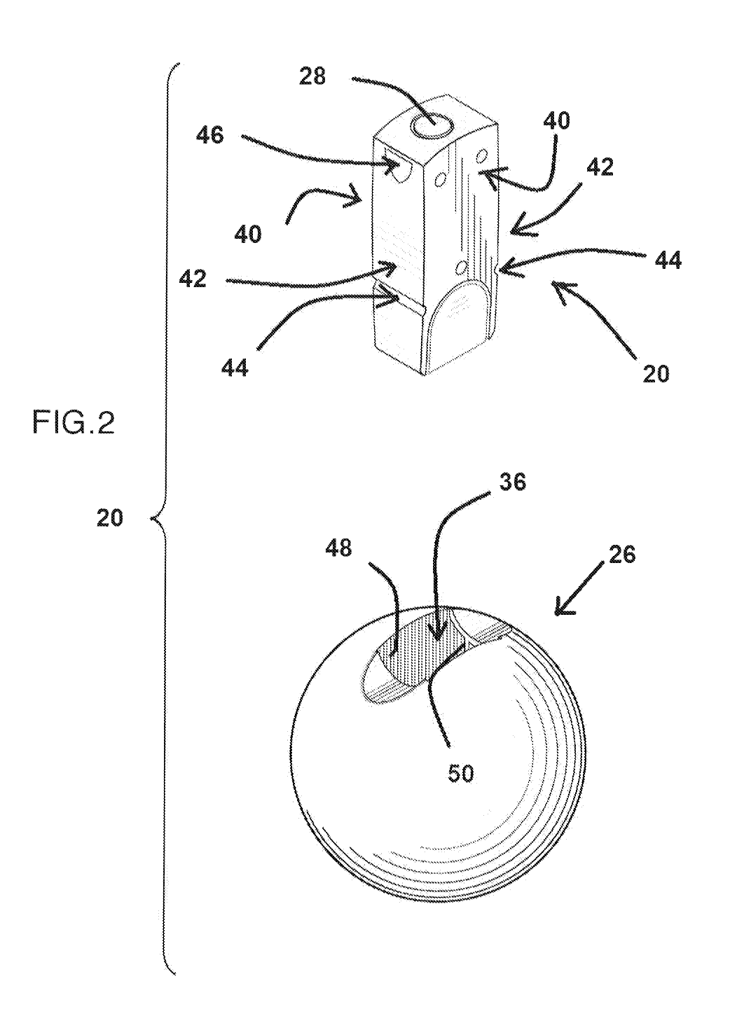

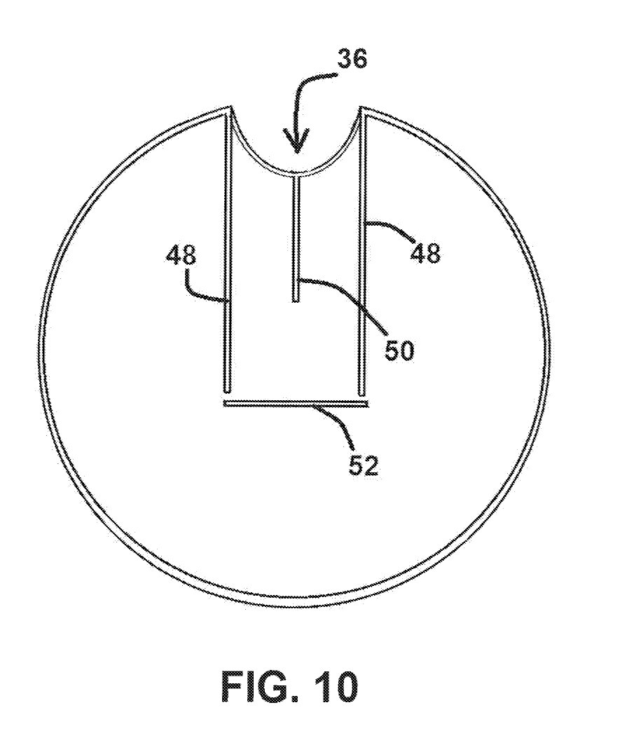

As shown in FIGS. 2 and 10, the socket 36 is defined
in part by a pair of parallel walls 48 against which frictionally engage in abutting, parallel relation, opposed walls 40 of the remote 22; and
in part by a pair of flanges 50 against which frictionally engage in abutting, perpendicular relation, opposed side walls 42 of the remote 22.

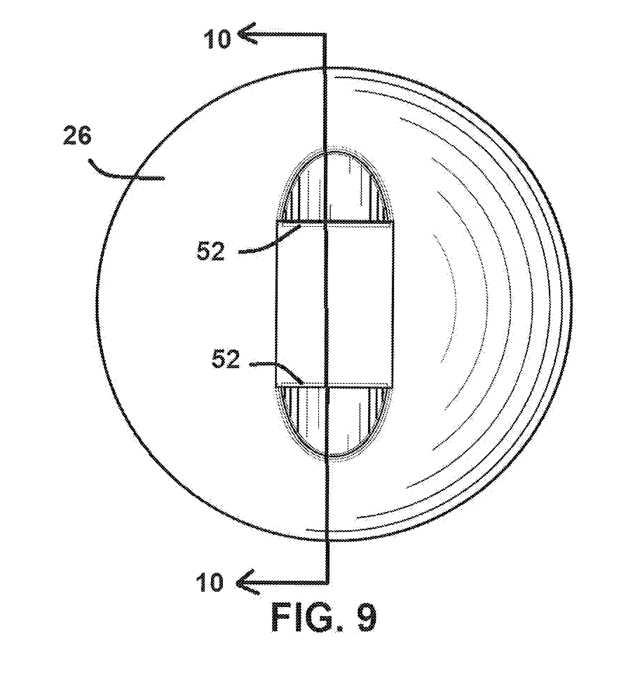

Mechanical engagement as between the remote 22 and the ornament 26 is provided by a pair of projecting flanges 52 (shown in FIG. 9 and FIG. 10) which deform as the remote 22 is slid into the socket 36 and, when the remote 22 is fully engaged in the socket 36, spring into grooves 44.

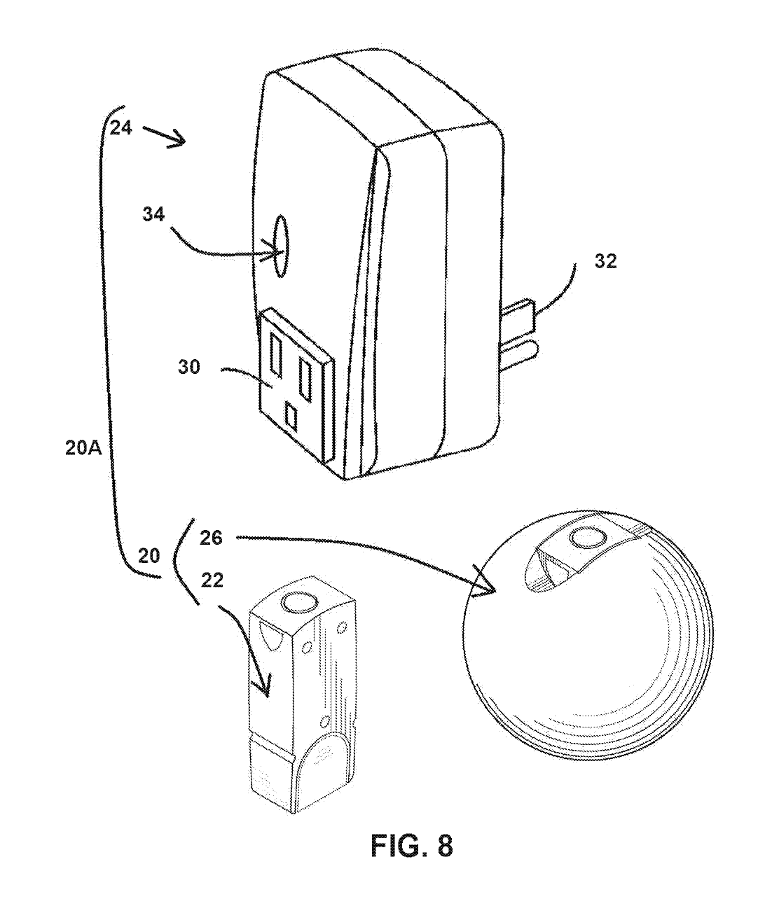

The apparatus 20 is, in another exemplary embodiment, used as part of a system 20A, shown in FIG. 8, which further includes an assembly 24. The assembly 24 will be seen to include an electrical receptacle 30 and an electrical plug 32 and to be adapted such that, when the plug 32 is engaged in a wall receptacle (not shown), the assembly 24 is mounted to the wall, in the manner of a wall timer (not shown).

The assembly 24 will be understood to include an interior circuit (not shown) and a user-manipulable switch 34.

The interior circuit has a first configuration and a second configuration and is adapted for movement between the first and second configurations in response to the wireless remote 22.

That is, in use, manipulation of the switch 28 from the inactive position to the active position, i.e. depression of the button thereof, can cause the circuit to move between the first configuration and the second configuration and vice-versa.

Details of the interior circuitry of the remote 22 and the assembly 24 are not shown nor described, as these are a matter of routine to persons of ordinary skill in the art. In this regard, reference is made to US 2009/0267789, the disclosure of which is incorporated herein by reference in its entirety.

When in use [i.e. when the plug 32 of the assembly 24 is mounted in a wall socket or the like] and in the first configuration of the circuit, the plug 32 and the receptacle 30 are electrically coupled together and the receptacle 30 is live. In the second configuration of the circuit, the receptacle 30 is dead.

The user-selectable switch 34 of the assembly 24 works in a manner analogous to the workings of the switch 28 of the remote 22, i.e., in use, selection of the switch 34 of the assembly 24 causes the circuit to move between the first configuration and the second configuration.

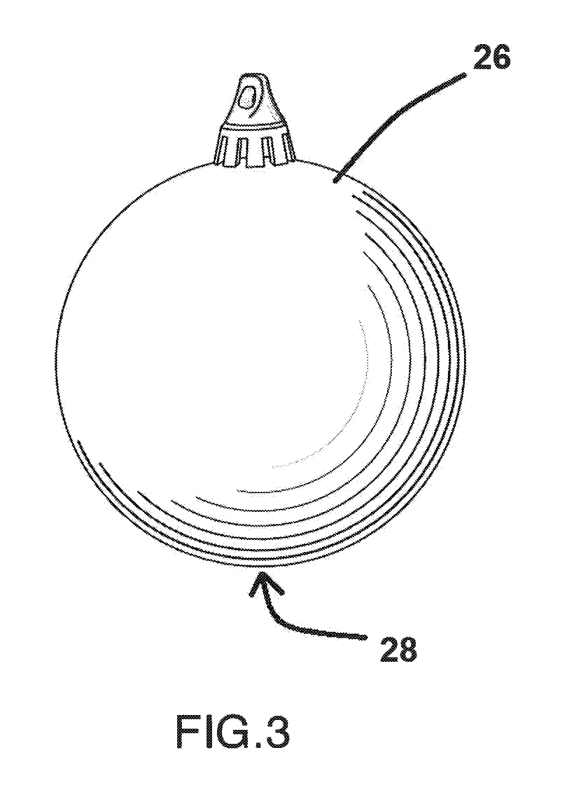

With further reference to FIG. 3, it will be understood that the switch 28 of the remote 22 presents downwardly and, when the ornament 26 is suspended in a conventional manner from a tree (not shown), the switch is manipulable by the thumb of a hand grasping the Christmas ball.

Persons of ordinary skill will readily recognize that the above produces significant advantage when in use, for example, with a light string suspended from a tree. In order to turn the light string on or off, a user need merely select the switch on the remote rather than, for example, withdrawing the plug of the light string from a wall socket as is commonly done, or bending down beneath the tree to switch off a power bar. [It is noted that the assembly of the exemplary embodiment illustrated includes a switch, thereby to permit operation of the apparatus in a manner identical to the operation of a conventional power bar; it should be understood that this switch is contemplated to be used in circumstances wherein the remote battery has died and a replacement has not yet been procured.

The configuration of the remote and ornament parts of the apparatus allows for economies of scale in the manufacture of the remote, and interchangeability of the ornament.

For example, if a homeowner decides to change the colours of the decorative balls he or she uses for decoration, he or she merely needs to replace the existing ornament with a new ornament of a matching or complementary colour. In this regard, the remotes and assemblies are advantageously sold as part of a system, along with a variety of balls of varying shapes, colours and sizes, thereby to permit the ball carrying the remote to match or complement the other balls on the tree with which that ball is used.

Finally, it is to be understood that while but two embodiments of the present invention have been herein shown and described, it will be understood that various changes may be made.

For example, wherein a push-button switch is shown on both the assembly and the remote, the switch could take the form of, for example, toggle switch, rocker switch and touch sensor.

Further, whereas the assembly is shown in the form factor of a wall-mountable switch timer, with a single receptacle, the assembly could equally be defined by a power bar or a splitter cube, with multiple receptacles.

As well, it is possible for the remote to be constructed integrally and indivisible from the ball, although this has drawbacks, since economics would likely dictate that only a finite number of different styles could be sold, and this would detract from consumer acceptance.

Further, a timer could be incorporated into the assembly, to increase functionality of the device.

As well, whereas a friction and mechanical fit is illustrated, the remote could engage the ornament in, for example, screw-fit relation.

Moreover, whereas the description suggests that the assembly and apparatus are sold together as part of a mating system, it will be understood that the apparatus could be sold for use with wirelessly-actuable power bars otherwise commonly available in the market.

Accordingly, the invention should be understood as limited only by the claims appended hereto, purposively construed.

Whereas, the present invention has been described in relation to the drawings attached hereto, it should be understood that other and further modifications, apart from those shown or suggested herein, may be made within the spirit and scope of this invention.

What is claimed is:

1. Apparatus for use with an assembly,
the assembly being of the type including an electrical receptacle, an electrical plug and a circuit, the circuit:
having a first configuration wherein, in use, the plug and the receptacle are electrically coupled together and the receptacle is live;
having a second configuration wherein the receptacle is dead; and
being adapted for movement between the first and second configurations in response to a wireless signal,
the apparatus comprising:
a wireless remote having a user-manipulable switch and adapted to produce the signal responsive to manipulation of the switch; and
a tree ornament adapted to releasably receive the remote.

2. Apparatus according to claim 1, wherein
the switch has an inactive position and an active position and is biased for movement towards the inactive position; and
manipulation of the switch from the inactive position to the active position causes the circuit to move between the first configuration and the second configuration.

3. Apparatus according to claim 1, wherein the tree ornament is a Christmas ball.

4. Apparatus according to claim 3, wherein
the Christmas ball has a socket; and
in use:
the socket presents downwardly; and
the switch presents downwardly and is manipulable by the thumb of a hand grasping the Christmas ball.

5. Apparatus according to claim 4, wherein the tree ornament is adapted to releasably receive the remote in one or more of frictional and mechanical engagement.

6. Apparatus according to claim 2, wherein the switch is a button.

7. Apparatus according to claim 4, wherein the switch is a button.

8. A system comprising:
wireless remotes;
tree ornaments, each adapted to releasably receive one of the remotes.

9. A system according to claim 8, further comprising
assemblies, each assembly including an electrical receptacle, an electrical plug and a circuit, the circuit: having a first configuration wherein, in use, the plug and the receptacle are electrically coupled together and the receptacle is live; having a second configuration wherein the receptacle is dead; and being adapted for movement between the first and second configurations in response to one of the wireless remotes.

10. A system according to claim 9, wherein each assembly is adapted such that, when the plug is engaged in a wall receptacle, said each assembly is mounted to the wall.
